(19) United States
(12) Patent Application Publication
(10) Pub. No.: US 2013/0021985 A1
(43) Pub. Date: Jan. 24, 2013

(54) RADIO COMMUNICATION APPARATUS AND RADIO COMMUNICATION METHOD

(71) Applicant: Katsuhiro IKEDA, Yokosuka (JP)

(72) Inventor: Katsuhiro IKEDA, Yokosuka (JP)

(73) Assignee: FUJITSU LIMITED, Kawasaki-shi (JP)

(21) Appl. No.: 13/447,747

(22) Filed: Apr. 16, 2012

(30) Foreign Application Priority Data
Jul. 22, 2011 (JP) 2011-161012

(51) Int. Cl. H04W 72/04

(52) U.S. Cl. 370/329

(57) ABSTRACT

A radio communication apparatus includes a mapper having a first generator that generates third data by inverting code of first data to be mapped to a frequency domain that corresponds to frequency allocated resources, and a selector that selects the first data, second data to be mapped to the frequency domain that corresponds to frequency allocated resources, the third data generated by the first generator 2, and zero. The mapper maps to the frequency domain that corresponds to frequency allocated resources, the first data, the second data, the third data, and zero selected and output by the selector.

### CROSS REFERENCE TO RELATED APPLICATIONS

This application is based upon and claims the benefit of priority of the prior Japanese Patent Application No. 2011-161012, filed on Jul. 22, 2011, the entire contents of which are incorporated herein by reference.

### FIELD

The embodiments discussed herein are related to radio communication.

### BACKGROUND

A conventional orthogonal frequency division multiplexing (OFDM) radio communication apparatus has a transmission circuit that performs serial/parallel conversion of an input signal, generates a signal for each subcarrier, diffuses and converts the data of each subcarrier into a time based waveform, and rotates a portion of the time based waveform converted signal, a portion corresponding to a desired period (see, for example, Japanese Laid-Open Patent Publication No. 2007-20072). Further, a conventional fast Fourier transform (FFT) computing device has a function of storing output from a butterfly processor (exclusive of the data of unused subcarriers) to buffer memory and sequentially outputting the stored data (see, for example, Japanese Laid-Open Patent Publication No. 2002-26859).

Further, a conventional FFT computing device has a function of storing the output of a butterfly processor to buffer memory and sequentially outputting the stored data exclusive of the data of an unused subcarrier (see, for example, Japanese Laid-Open Patent Publication No. 2002-26859). A conventional butterfly processor inputs pixel data at each clock, successively stores the input data to a first register group and a second register group at every fourth clock, sends the pixel data in the respective register groups to a shift register at every eighth clock, successively outputs 2 bits starting from the lower bits of the rearranged data, and performs addition at an adder and subtraction at another adder (see, for example, Japanese Laid-Open Patent Publication No. 2000-29863).

A conventional orthogonal frequency division multiple access (OFDMA) signal transmission apparatus performs butterfly computation with respect to an inverse FFT (IFFT) computation block, exclusive of the IFFT computation block corresponding to a subcarrier to which user data has not been allocated and generates a subcarrier time waveform to thereby, perform Fourier transform with respect to subcarriers, exclusive of subcarriers to which data has not been allocated (see, for example, Japanese Laid-Open Patent Publication No. 2009-246516). Further, a conventional communication apparatus arranges at the positions of specified subcarriers, discrete Fourier transform (DFT) signals related to subcarrier mapping; and once the insertion position of “0” is clear, fixes the output of “0” concerning a portion outputting “0” (see, for example, Japanese Laid-Open Patent Publication No. 2008-131410).

A conventional arithmetic processing unit shifts a data signal x(n) (n=0, . . . , N−1) that has a data length N (N=odd number) and is symmetrical about the (N−1)/2-th bit data, by (N+1)/2 bits; performs DFT with respect to the shifted data signal x′(n); and obtains a DFT data signal X(k) (k=0, . . . , N−1) (see, for example, Japanese Laid-Open Patent Publication No. 2010-152768). Further, a conventional calculating device includes a single multi-radix butterfly unit that calculates all butterflies of various sizes occurring in a flow; expresses DFT by a basic butterfly sequence according to size; schedules DFT by a nested loop sequence; and customizes the nested loop according to DFT size (see, for example, Japanese Laid-Open Patent Publication No. 2010-16831).

However, with the conventional radio communication apparatuses, transmission data is mapped to a frequency domain that corresponds to frequency allocated resources and when IFFT is performed, the number of butterfly calculation steps in the IFFT is great, resulting in a large volume of calculations. Thus, problems arise such as the scale of the IFFT circuit becomes large, power consumption increases, and processing delay increases.

### SUMMARY

According to an aspect of an embodiment, a radio communication apparatus includes a mapper having a first generator that generates third data by inverting code of first data to be mapped to a frequency domain that corresponds to frequency allocated resources, and a selector that selects the first data, second data to be mapped to the frequency domain that corresponds to frequency allocated resources, the third data generated by the first generator 2, and zero. The mapper maps to the frequency domain that corresponds to frequency allocated resources, the first data, the second data, the third data, and zero selected and output by the selector.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a mapper of a radio communication apparatus according to a first embodiment.

FIG. 2 is a flowchart of a radio communication method according to the first embodiment.

FIG. 3 is a block diagram of the radio communication apparatus according to a second embodiment.

FIGS. 4, 5, 6, 7, and 8 are block diagrams of a baseband device of the radio communication apparatus according to the second embodiment.

FIG. 9 is a block diagram of a subcarrier mapper of the radio communication apparatus according to a second embodiment.

FIG. 10 is a block diagram of an IFFT device of the radio communication apparatus according to the second embodiment.

FIG. 11 is a block diagram of another example of the IFFT device according to the second embodiment.

FIG. 12 is a view depicting a frame format of a data arrangement example after subcarrier mapping processing according to the second embodiment.

FIGS. 13 and 14 are views depicting first stage butterfly computation processing according to the second embodiment.

FIG. 15 is view depicting a frame format of a data arrangement after first stage butterfly computation processing according to the second embodiment.

FIG. 16 is a block diagram of an example of the first stage butterfly processor of the radio communication apparatus according to the second embodiment.

FIG. 17 is a view depicting a frame format of a data arrangement example of data after subcarrier mapping according to the second embodiment.

FIGS. 18 and 19 are views of the first stage butterfly computation processing according to the second embodiment.

FIG. 20 is view depicting a frame format of a data arrangement example after the first stage butterfly computation processing according to the second embodiment.

FIG. 21 is a view depicting a frame format of a data arrangement example after subcarrier mapping processing according to the second embodiment.

FIGS. 22 and 23 are views depicting the first stage butterfly computation processing according to the second embodiment.

FIG. 24 is a view depicting a frame format of a data arrangement example after the first stage butterfly computation processing according to the second embodiment.

FIG. 25 is a view depicting a frame format of a data arrangement example after the subcarrier mapping processing according to the second embodiment.

FIGS. 26 and 27 are views depicting the first stage butterfly computation processing according to the second embodiment.

FIG. 28 is a view depicting a frame format of a data arrangement example after first stage butterfly computation processing according to the second embodiment.

FIG. 29 is a flowchart of the radio communication method according to the second embodiment.

FIG. 30 is a block diagram of an example of the subcarrier mapper of the radio communication apparatus according to a third embodiment.

FIG. 31 is a block diagram of another example of the subcarrier mapper of the radio communication apparatus according to the third embodiment.

FIG. 32 is a block diagram of an example of the IFFT device of the radio communication apparatus according to the third embodiment.

FIG. 33 is a block diagram of another example of the IFFT device of the radio communication apparatus according to the third embodiment.

FIG. 34 is a flowchart of the radio communication method according to the third embodiment.

### DESCRIPTION OF EMBODIMENTS

Preferred embodiments of the present invention will be explained with reference to the accompanying drawings. In each of the embodiments, identical components are assigned the same reference numeral and redundant description is omitted.

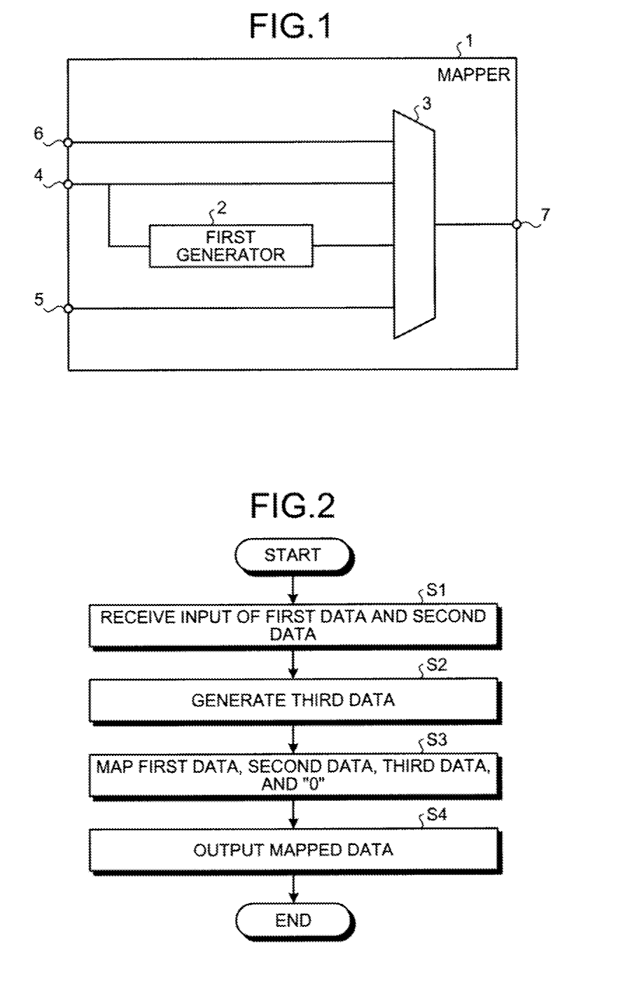

FIG. 1 is a block diagram of a mapper according to a first embodiment. In a transmitter of a radio communication apparatus, a mapper 1 depicted in FIG. 1, for example, allocates to frequency domains that correspond to frequency allocated resources, data that is to be transmitted. An overall configuration of the radio communication apparatus is not depicted. As depicted in FIG. 1, the radio communication apparatus includes the mapper 1, which has a first generator 2 and a selector 3.

The first generator 2 generates third data by inverting the code of first data to be mapped to a frequency domain that corresponds to frequency allocated resources. The first data is input from a first input terminal 4 of the mapper 1. The selector 3 selects the first data, second data to be mapped to a frequency domain, which corresponds to frequency allocated resources, the third data generated by the first generator 2, and zero.

The second data is input from a second input terminal 5 of the mapper 1. The zero data is input from a third input terminal 6. The zero data may be generated within the mapper 1. The mapper 1 maps to a frequency domain that corresponds to frequency allocated resources, the first data, the second data, the third data, and zero selected and output by the selector 3. The mapped data is output from an output terminal 7 of the mapper 1.

FIG. 2 is a flowchart of a radio communication method according to the first embodiment. As depicted in FIG. 2, in the radio communication method when mapping begins, the first data and the second data, which are mapped to the a frequency domain that corresponds to frequency allocated resources, are input to the mapper 1 of the radio communication apparatus (step S1). The radio communication apparatus, at the mapper 1 and by the first generator 2, generates the third data by inverting the code of the first data (step S2).

The radio communication apparatus, at the mapper 1 and by the selector 3, maps the first data, the second data, the third data, and zero to a frequency domain that corresponds to frequency allocated resources (step S3). The radio communication apparatus outputs the mapped data from the mapper 1 (step S4), and ends the processing.

According to the first embodiment, with a configuration that performs IFFT with respect to data mapped to the a frequency domain that corresponds to frequency allocated resources, first stage IFFT butterfly computation results are output from the mapper 1. Accordingly, by omitting first stage IFFT butterfly computation, the volume of IFFT computations can be reduced, thereby enabling the size of the IFFT circuit to be reduced. Consequently, power consumption of the radio communication apparatus can be reduced as well as the delay of processing at the radio communication apparatus.

A second embodiment is an application of the radio communication apparatus and the radio communication method according to the first embodiment to, for example, a radio communication apparatus that uses a single carrier frequency division multiple access (SC-FDMA) scheme to perform transmission. The SC-FDMA scheme, for example, is planned to be adopted as a standard for modem transmitters in next generation radio communication standards, Evolved Universal Terrestrial Radio Access (E-UTRA).

Here, without limitation to the SC-FDMA scheme, another radio communication scheme such as OFDMA may be adopted. A cellular telephone and base station apparatus may be given as one example of the radio communication apparatus.

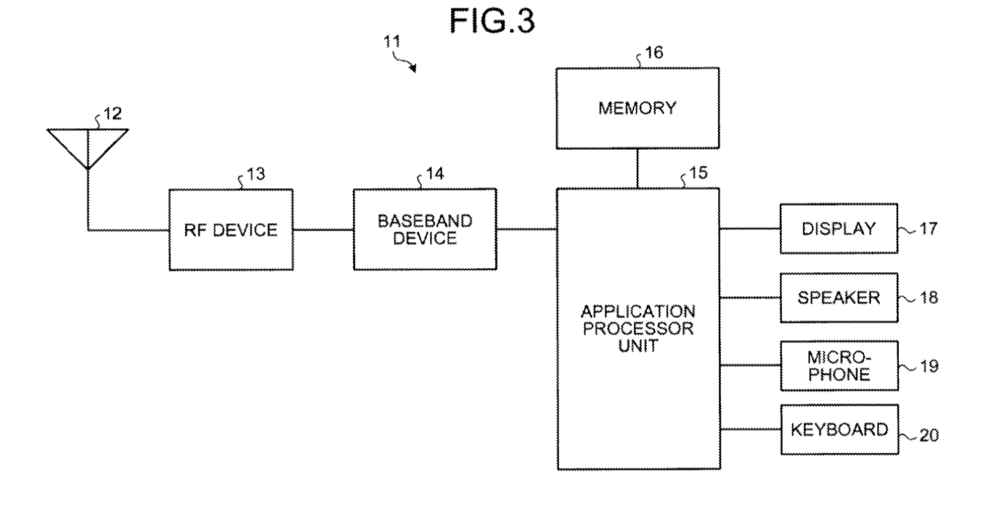

FIG. 3 is a block diagram of the radio communication apparatus according to the second embodiment. As depicted in FIG. 3, a radio communication apparatus 11 includes an antenna 12, a radio frequency (RF) device 13 that performs radio transmission and reception, and a baseband device 14 that performs baseband processing. The RF device 13 and the baseband device 14 may be provided on respectively independent, integrated circuit (IC) chips or on a single IC chip.

The radio communication apparatus 11 includes an application processor unit 15 that executes applications. The application processor unit 15 may be provided on an independent IC chip. A memory 16, an output device such as a display 17 and speaker 18, as well as an input device such as a microphone 19 and a keyboard 20 may be connected to the application processor unit 15.

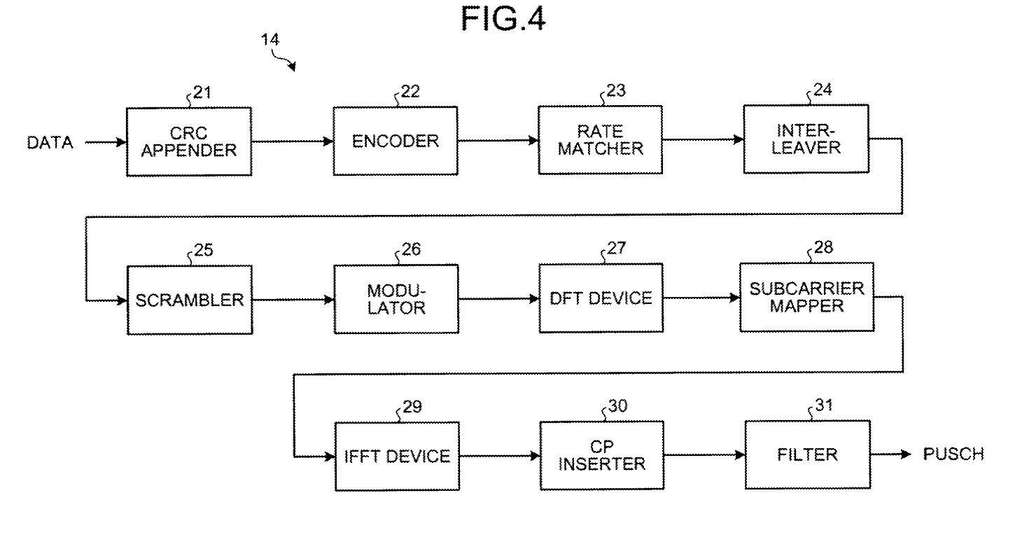

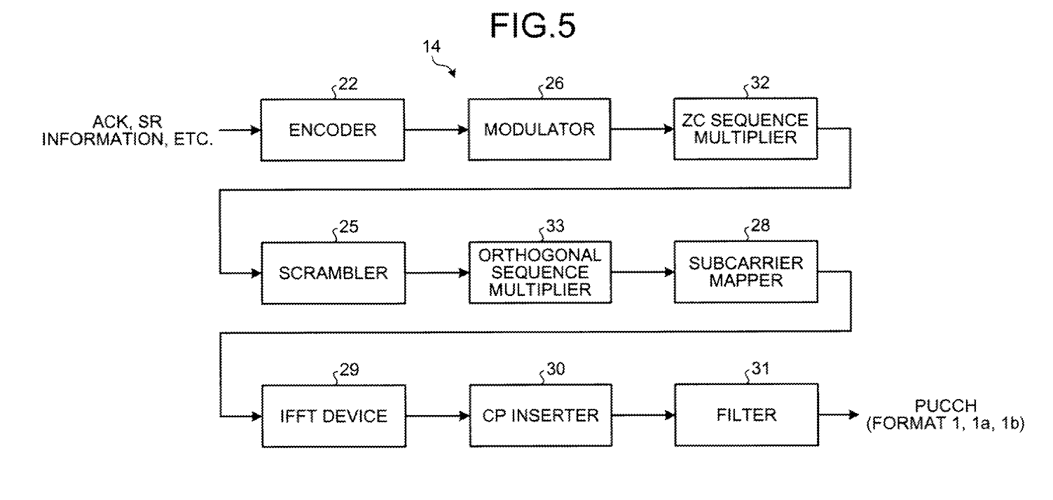

FIG. 4 is a block diagram of a baseband device transmitting a physical uplink shared channel (PUSCH). As depicted in FIG. 4, when transmitting a PUSCH, the baseband device 14 includes a cyclic redundancy check (CRC) appender 21, an encoder 22, a rate matcher 23, an interleaver 24, a scrambler 25, a modulator 26, a DFT device 27, a subcarrier mapper 28, an IFFT device 29, a cyclic prefix (CP) inserter 30, and a filter 31.

Data inserted into the baseband device 14 is appended with CRC information by the CRC appender 21, encoded by the encoder 22, and subject to rate match processing by the rate matcher 23. The data output from the rate matcher 23 is interleaved by the interleaver 24, scrambled by the scrambler 25, modulated by the modulator 26, and converted into frequency sequence data by the DFT device 27.

The frequency sequence data is mapped to subcarriers by the subcarrier mapper 28 and converted into time domain data by the IFFT device 29. The CP inserter 30 inserts a cyclic prefix into the time domain data. The data output from the CP inserter 30 passes through the filter 31 and is output from the baseband device 14.

FIG. 5 is a block diagram of the baseband device transmitting a physical uplink control channel (PUCCH). As depicted in FIG. 5, when transmitting a PUCCH of a format 1, 1a, or 1b, the baseband device 14 includes the encoder 22, the modulator 26, a Zadoff-Chu (ZC) sequence multiplier 32, the scrambler 25, an orthogonal sequence multiplier 33, the subcarrier mapper 28, the IFFT device 29, the CP inserter 30, and the filter 31.

Data such as acknowledgment (ACK) and scheduling request (SR) information input into the baseband device 14 passes through the encoder 22 and the modulator 26 and is subject to ZC sequence multiplication processing by the ZC sequence multiplier 32. The data output from the ZC sequence multiplier 32 passes through the scrambler 25, is subject to orthogonal sequence multiplication processing by the orthogonal sequence multiplier 33, passes through the subcarrier mapper 28, the IFFT device 29, the CP inserter 30, and the filter 31, and is output from the baseband device 14.

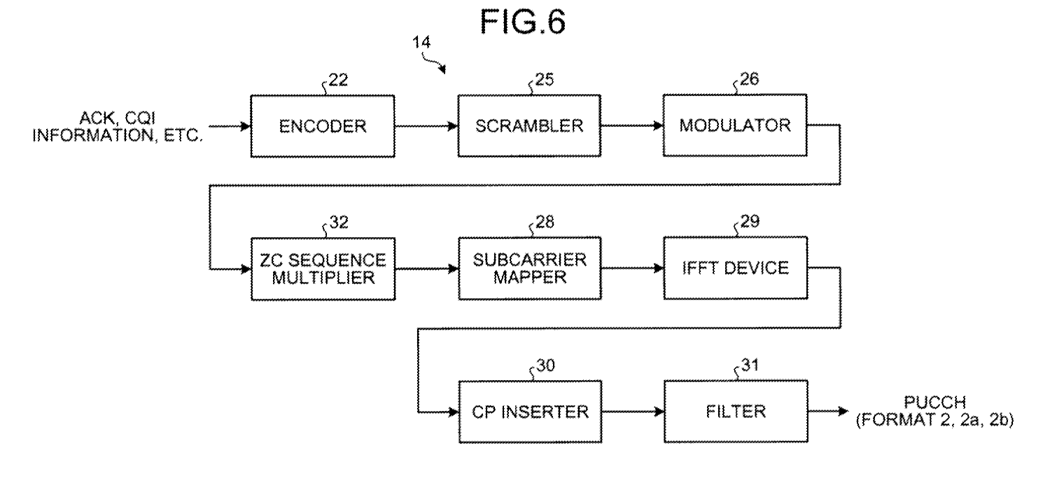

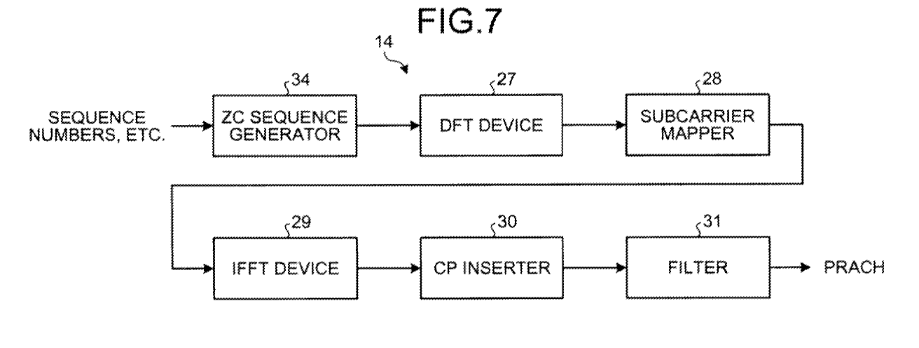

FIG. 6 is a block diagram of the baseband device transmitting a PUCCH. As depicted in FIG. 6, when transmitting a PUCCH of a format 2, 2a, or 2b, the baseband device 14 includes the encoder 22, the scrambler 25, the modulator 26, the ZC sequence multiplier 32, the subcarrier mapper 28, the IFFT device 29, the CP inserter 30, and is the filter 31.

Data such as ACK and channel quality indicator (CQI) information input into the baseband device 14 passes through the encoder 22, the scrambler 25, the modulator 26, the ZC sequence multiplier 32, the subcarrier mapper 28, the IFFT device 29, the CP inserter 30, and the filter 31, and is output from the baseband device 14.

FIG. 7 is a block diagram of the baseband device transmitting a physical random access channel (PRACH). As depicted in FIG. 7, when transmitting a PRACH, the baseband device 14 includes a ZC sequence generator 34, the DFT device 27, the subcarrier mapper 28, the IFFT device 29, the CP inserter 30, and the filter 31.

Based on data such as sequence numbers input into the baseband device 14, ZC sequence data is generated by the ZC sequence generator 34. The data output from the ZC sequence generator 34 passes through the DFT device 27, the subcarrier mapper 28, the IFFT device 29, the CP inserter 30, and the filter 31, and is output from the baseband device 14.

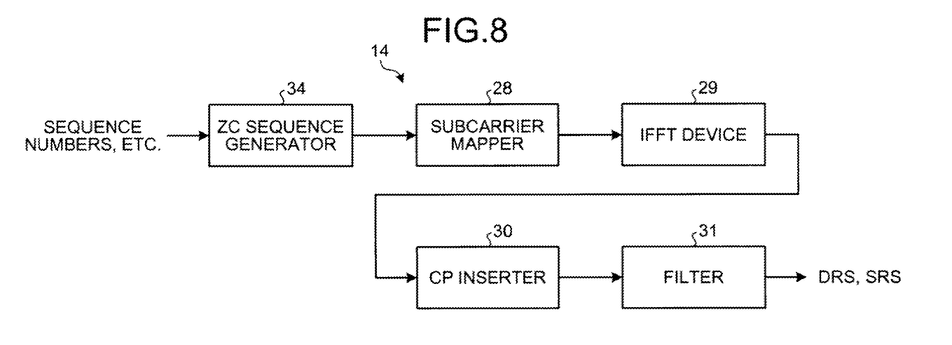

FIG. 8 is a block diagram of the baseband device transmitting a demodulation reference signal (DRS) or sounding reference signal (SRS). As depicted in FIG. 8, when transmitting a DRS or a SRS, the baseband device 14 includes the ZC sequence generator 34, the subcarrier mapper 28, the IFFT device 29, the CP inserter 30, and the filter 31.

Based on data such as sequence numbers input into the baseband device 14, ZC sequence data is generated by the ZC sequence generator 34. The data output from the ZC sequence generator 34 passes through the subcarrier mapper 28, the IFFT device 29, the CP inserter 30, and the filter 31, and is output from the baseband device 14.

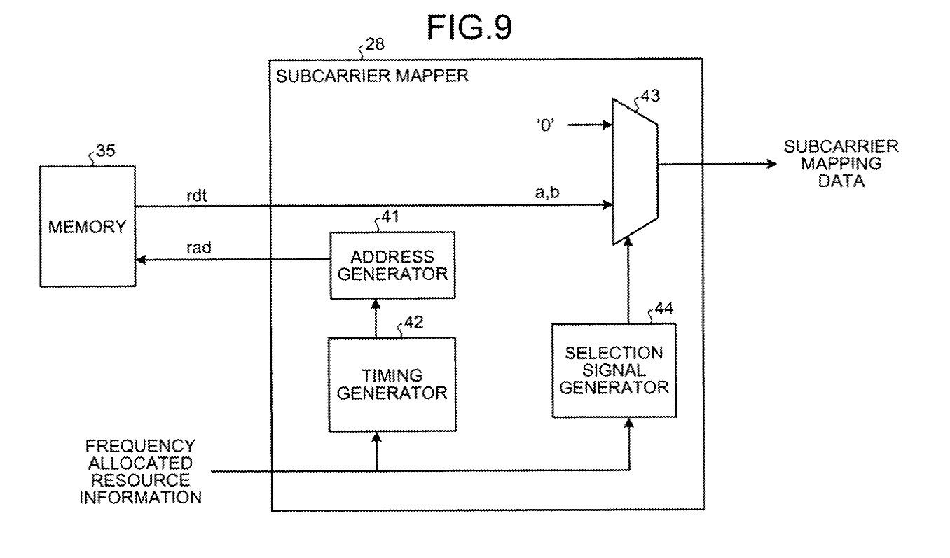

FIG. 9 is a block diagram of the subcarrier mapper according to the second embodiment. As depicted in FIG. 9, the subcarrier mapper 28, for example, may be connected to a memory 35. The memory 35 may store therein processing results of, for example, the DFT device 27 (see FIGS. 4 and 7), the orthogonal sequence multiplier 33 (see FIG. 5), the ZC sequence multiplier 32 (see FIG. 6), and/or the ZC sequence generator 34 (see FIG. 8) upstream from the subcarrier mapper 28. The data mapped to the subcarriers at the subcarrier mapper 28 is a data string of multiple numeric values.

Alternatively, the memory 35 may store therein table information for sequence generation. In this example, the processing results obtained upstream from the subcarrier mapper 28 are stored to the memory 35. The memory 35 may be any one or more among random access memory (RAM), read only memory (ROM), and a flip flop.

Frequency allocated resource information, for example, is provided to the subcarrier mapper 28 from a decoder (not depicted) that decodes a control signal received by the radio communication apparatus 11. The frequency allocated resource information, for example, includes an allocation starting point and count information indicating from which resource and to how many resources allocation is to be performed. The subcarrier mapper 28 includes an address generator 41, a timing generator 42, a selector 43, and a selection signal generator 44.

The timing generator 42, based on the frequency allocated resource information, establishes the start-timing of readout from the memory 35. For example, when the resource allocation starting point is reached, the timing generator 42 outputs a pulsed signal to the address generator 41, as the readout start-timing. For example, when a cycle corresponding to the readout of data for the number of resources to which allocation is to be performed has elapsed, the timing generator 42 outputs a pulsed signal that ends the data readout.

The address generator 41, based on the readout start-timing established by the timing generator 42, generates a read address (rad) of the memory 35. For example, upon a pulsed signal being input from the timing generator 42 as the read start-timing, the address generator 41 generates and outputs, for example, a read address (rad) at the head of the memory 35 and starts an internal counter. For example, until the input of a pulsed signal from the timing generator 42 as the readout end-timing, the address generator 41 increments the internal counter and, generates and outputs read addresses (rad). For example, upon a pulsed signal being input from the timing generator 42 as the readout end-timing, the address generator 41 stops the counter and terminates the output of read addresses (rad).

When the memory 35 stores therein table information for sequence generation, although read address control according to the sequence information to be generated is input, since there is no direct relation with the subcarrier mapping by the subcarrier mapper 28, depiction and description are omitted.

The selection signal generator 44, based on the frequency allocated resource information, generates a selection signal that controls the selector 43. For example, until the resource allocation starting point is reached, the selection signal generator 44 generates and outputs, for example, a selection signal that causes the selector 43 to select zero. Until the number of resources to which allocation is to be performed is reached from the resource allocation starting point, the selection signal generator 44 generates and outputs a selection signal of, for example, 1, which causes the selector 43 to select read data (rdt) readout from the memory 35. After the number of resources to which allocation is to be performed is reached from the resource allocation starting point, the selection signal generator 44 generates and outputs a selection signal that causes the selector 43 to select zero.

The selector 43, based on the selection signal generated by the selection signal generator 44, selects zero or the read data (rdt) readout from the memory 35 based on the read address generated by the address generator 41. The selector 43 maps the selected data to subcarriers of a frequency domain that corresponds to frequency allocated resources and outputs the resulting data as subcarrier mapping data.

Although data readout from the memory 35 may be input to the subcarrier mapper 28 via a block for performing orthogonal sequence multiplication processing and not directly, since there is no direct relation with subcarrier mapping processing at the subcarrier mapper 28, depiction and description are omitted (similarly with respect to a third embodiment).

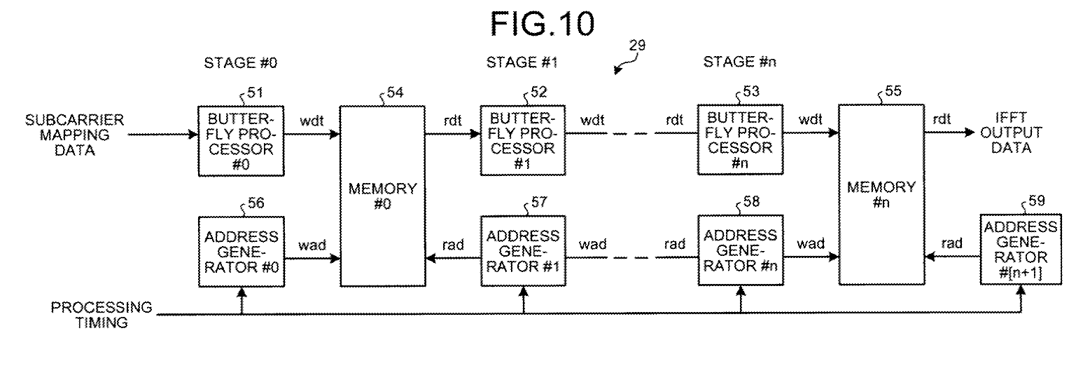

FIG. 10 is a block diagram of the IFFT device according to the second embodiment. As depicted in FIG. 10, the IFFT device 29, for example, includes [n+1]-stage butterfly processors#0 to #n 51, 52, 53, [n+1] memories#0 to #n 54, 55, and [n+2] address generators#0 to #[n+1] 56, 57, 58, 59, where n is an integer.

The first stage butterfly processor#0_51 performs butterfly computation with respect to the subcarrier mapping data output from the subcarrier mapper 28. For the sake of simplicity, the butterfly computation at the first stage butterfly processor#0_51 is regarded as stage #0. The butterfly computation results at the first stage butterfly processor#0_51 are written to the memory#0_54. The address generator#0_56, based on processing timing, generates a write address (wad) for when write data (wdt) is written to the memory#0_54.

The second stage butterfly processor#1_52 performs butterfly computation with respect to the butterfly computation results of the first stage butterfly processor#0_51, readout from memory#0_54. For the sake of simplicity, the butterfly computation at the second stage butterfly processor#1_52 is regarded as stage #1. The butterfly computation results of the second stage butterfly processor#1_52 are written to a memory (not depicted) that stores the butterfly computation results of the second stage butterfly processor#1_52.

The address generator#1_57, based on processing timing, generates a read address (rad) for when read data (rdt) is readout from the memory#0_54. The address generator#1_57, based on processing timing, generates a write address (wad) for when the write data (wdt) is written to the memory that stores the butterfly computation results of the second stage butterfly processor#1_52. For stages subsequent to stage #1, similar processing is performed.

The [n+1]-th stage butterfly processor#n_53 performs butterfly computation with respect to the butterfly computation results of the n-th stage butterfly processor (not depicted), readout from a memory (not depicted) that stores butterfly computation results of the n-th stage butterfly processor (not depicted). For the sake of simplicity, the butterfly computation at the [n+1]-th stage butterfly processor#n_53 is regarded as stage #n. The butterfly computation results at the [n+1]-th stage butterfly processor#n_53 are written to the memory#n_55.

The address generator#n_58, based on processing timing, generates a read address(rad) for when the read data (rdt) is readout from the memory (not depicted) storing the butterfly computation results of the n-th stage butterfly processor (not depicted). The address generator#n_58, based on processing timing, generates a write address (wad) for when the write data (wdt) is written to the memory#n_55.

The address generator#[n+1]_59, based on processing timing, generates a read address (rad) for when the read data (rdt) is readout of the memory#n_55. The IFFT device 29 outputs, as IFFT output data, the butterfly computation results of the [n+1]-th stage butterfly processor#n_53, readout from the memory#n_55. The IFFT output data is a data string of multiple numeric values. The configuration of the butterfly processor at each stage and the computation contents are commonly known and are thus, omitted herein.

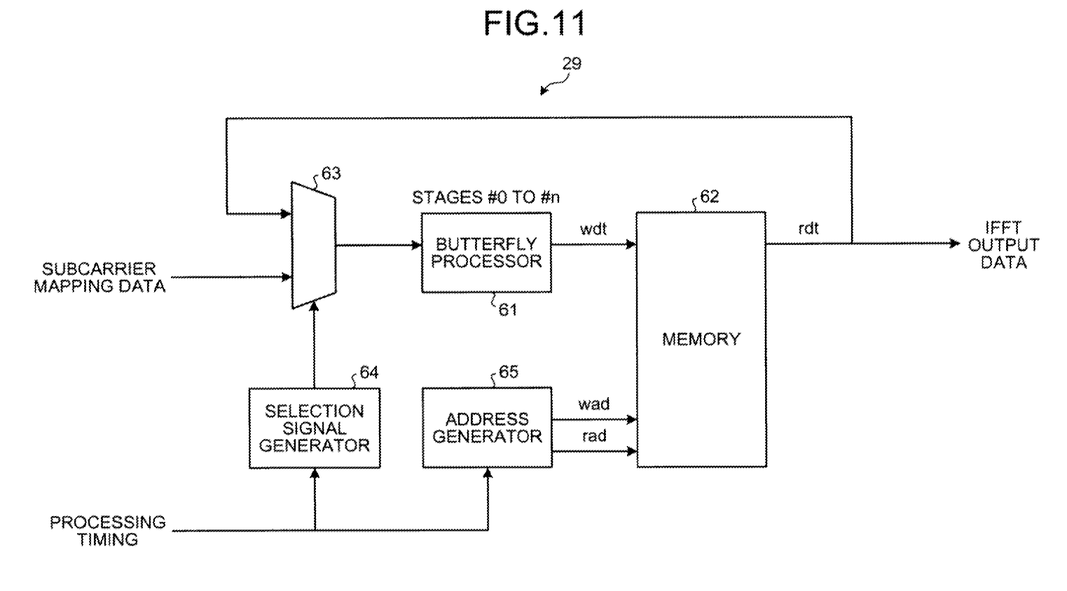

FIG. 11 is a block diagram of another example of the IFFT device according to the second embodiment. As depicted in FIG. 11, the IFFT device 29 includes a butterfly processor 61, a memory 62, a selector 63, a selection signal generator 64, and an address generator 65. The IFFT device 29 depicted in FIG. 11 is of a configuration that loops the butterfly computations at the butterfly processor 61 and the memory 62, for the stages #0 to #n.

The butterfly processor 61 performs the stage #0 to #n butterfly computations. The memory 62 stores the stage #0 to #n butterfly computation results output from the butterfly processor 61. The selection signal generator 64, based on processing timing, generates a selection signal that controls the selector 63.

Based on the selection signal generated by the selection signal generator 64 and when the butterfly processor 61 performs the stage #0 butterfly computation, the selector 63 selects and outputs to the butterfly processor 61, the subcarrier mapping data output from the subcarrier mapper 2. Based on the selection signal generated by the selection signal generator 64 and when the butterfly processor 61 performs the stage #1 to #n butterfly computations, the selector 63 selects and outputs to the butterfly processor 61, the stage #0 to #[n−1] butterfly computation results readout from the memory 62.

The address generator 65, based on processing timing, generates a write address (wad) for when the write data (wdt) is written to the memory 62 and a read address (rad) for when the read data (rdt) is readout from the memory 62. The IFFT device 29 outputs, as IFFT output data, the stage #n butterfly computation results readout from the memory 62.

An example of data arrangement after subcarrier mapping processing when the conditions of expression (1) are satisfied will be described.

$$\frac{{N}_{IFFT}}{2} \geq {N}_{RB}^{UL} {N}_{SC}^{RB} \qquad ( 1 )$$

In expression (1), N_{IFFT} is the IFFT size. When the IFFT device 29 performs IFFT by, for example, radix-2, the butterfly computation stage count is expressed as [log₂N_{IFFT}], using the IFFT size N_{IFFT}. For example, if N_{IFFT} is 16, the butterfly computation stage count in the IFFT device 29 is 4. For example, if N_{IFFT is} 2048, the butterfly computation stage count in the IFFT device 29 is 11.

Further, N^{UL}_{RB} is the system bandwidth expressed by the resource block (RB) count. N^{RB}_{SC} is the subcarrier count per 1 resource block. For example, assuming the subcarrier count per 1 resource block is 12, N_{IFFT is} 2048 and when N^{UL}_{RB} is 100, the system bandwidth is 20 MHz.

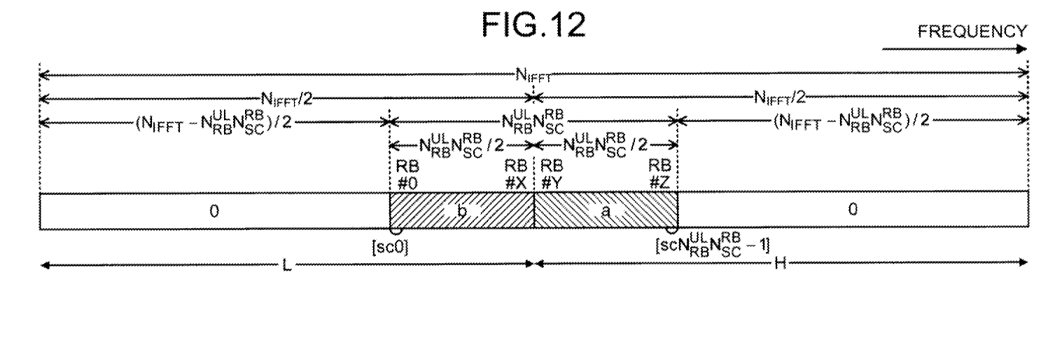

FIG. 12 is a view depicting a frame format of a data arrangement example after the subcarrier mapping processing under conditions satisfying expression (1). As depicted in FIG. 12, the data readout from the memory 35, i.e., the processing results obtained upstream from the subcarrier mapper 28 are mapped to subcarriers of the frequency domain that corresponds to the specified frequency-allocated-resources. The frequency allocated resources specify a continuous domain within the range of [N^{UL}_{RB}N^{RB}_{SC}], which is the center of N_{IFFT}.

In FIG. 12, X, Y and Z are expressed by the following equations (2a), (2b) and (2c).

$$\begin{matrix}X = ( \frac{{N}_{RB}^{UL}}{2} - 1 ) & ( 2 a ) \\ Y = ( \frac{{N}_{RB}^{UL}}{2} ) & ( 2 b ) \\ Z = ( {N}_{RB}^{UL} - 1 ) & ( 2 c )\end{matrix}$$

Zero is mapped to the frequency domain subcarriers to which processing results obtained upstream from the subcarrier mapper 28, have not been mapped. For the sake of convenience, in the subcarrier mapping example depicted in FIG. 12, [N_{IFFT}/2] that is on the side where the frequency is high is regarded as a portion on a high (H) side, and [N_{IFFT}/2] that is on the side where the frequency is low is regarded as a portion on a low (L) side. Data included among frequency-allocated resources on the H-side are regarded as data a, and data included among frequency-allocated resources on the L-side are regarded as data b. Data a and data b include 1 or more resource blocks. Under the conditions satisfying expression (1), mapping is performed in the order of zero, data b, data a, and zero, from the low frequency side.

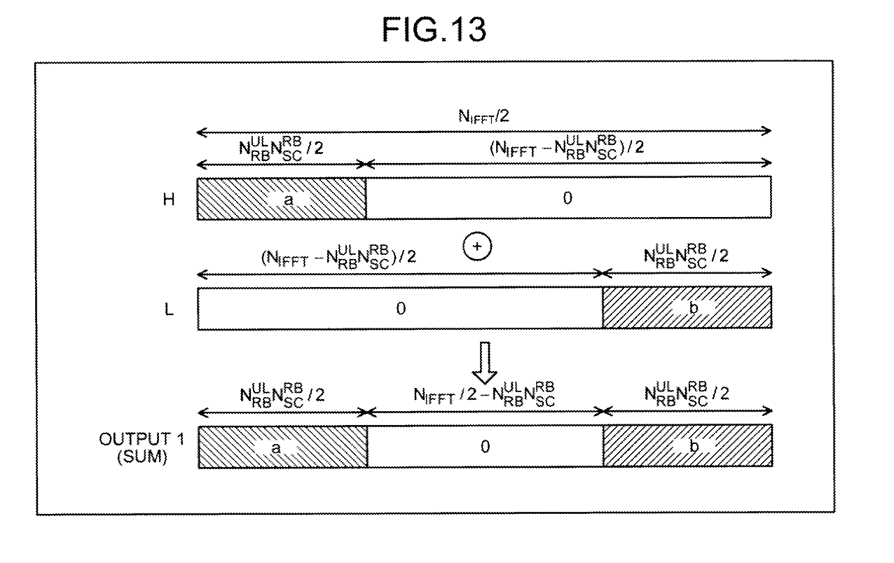

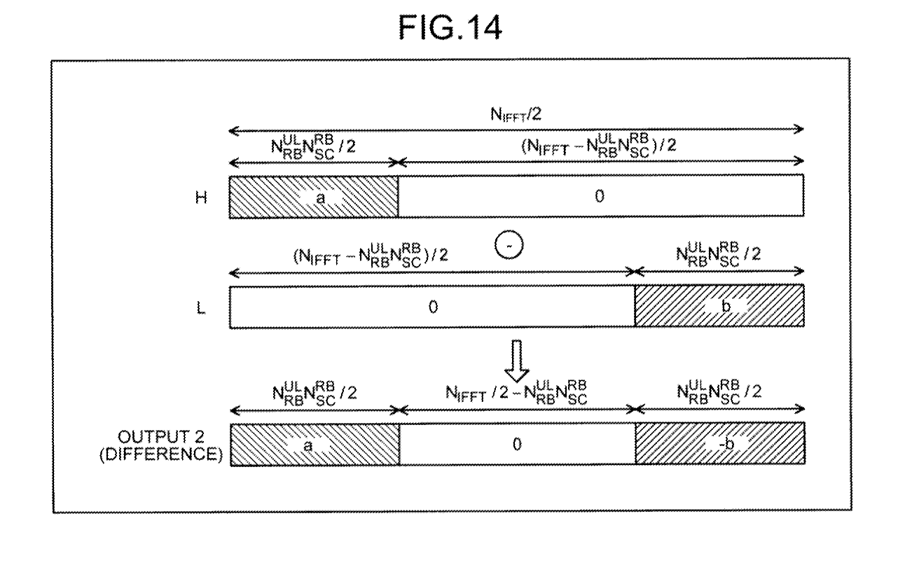

A data arrangement example after first stage butterfly computation processing when expression (1) is satisfied will be described. FIGS. 13 and 14 are views depicting first stage butterfly computation processing under conditions satisfying expression (1). In the first stage butterfly computation, all twiddle factors are 0. Accordingly, in the first stage butterfly computation, as depicted in FIG. 13, the H-side frequency allocated resources and the L-side frequency allocated resources are added. Further, as depicted in FIG. 14, the L-side frequency allocated resources are subtracted from the H-side frequency allocated resources.

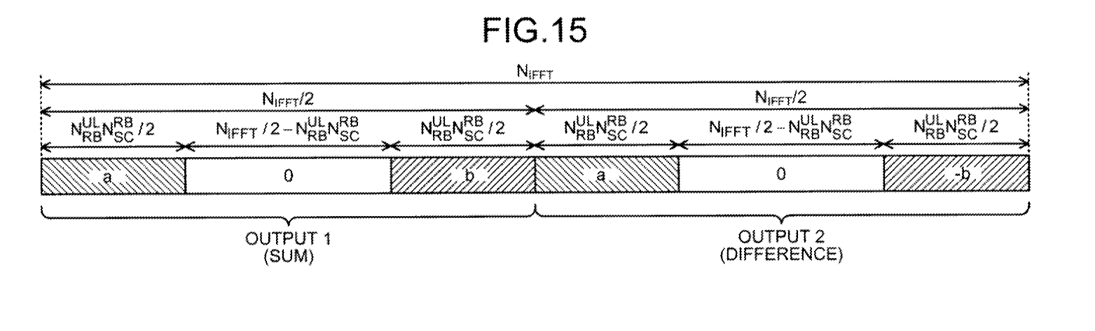

FIG. 15 is view depicting a data arrangement after first stage butterfly computation processing under conditions satisfying expression (1). As depicted in FIG. 15, after the first stage butterfly computation, output 1 (sum) depicted in FIG. 13 is arranged on the low frequency side, and output 2 (difference) depicted in FIG. 14 is arranged on the high frequency side. Therefore, arrangement is in the order of data a, zero, data b, data a, zero, and data [−b], from the low frequency side.

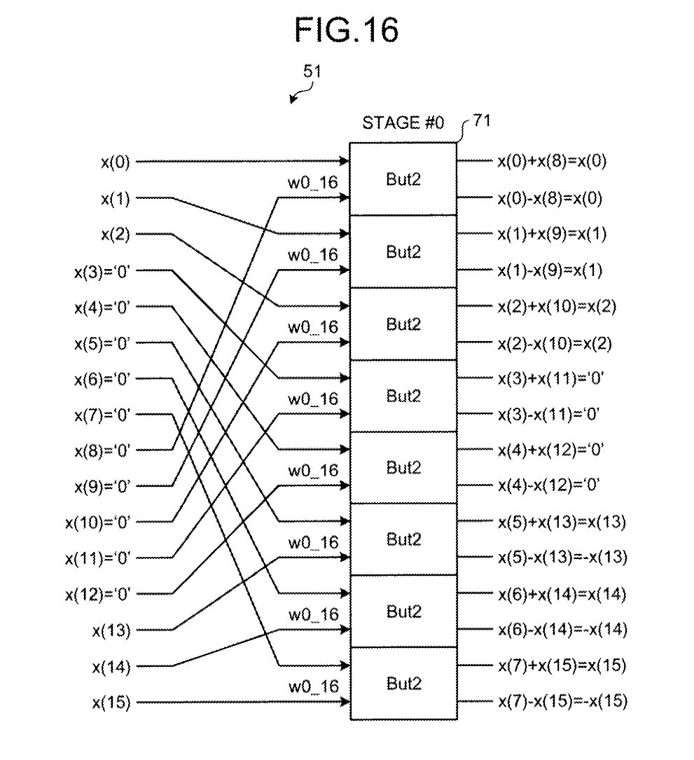

FIG. 16 is a block diagram of an example of the first stage butterfly processor according to the second embodiment. The first stage butterfly processor depicted in FIG. 16 is one in the case of, for example, radix-2 IFFT, where the IFFT size, N_{IFFT}, is for example, 16. As depicted in FIG. 16, the first stage butterfly processor#0_51, for example, includes 8 butterfly computation devices (Butt) 71. For example, among 16 input data items x(0) to x(15), x(0) to x(2) and x(13) to x(15) have resources, and x(3) to x(12) are zero. In this case, output data from the 8 butterfly computation devices 71 is x(0) to x(2), x(13) to x(15), [−x(13)] to [−x(15)], and zero.

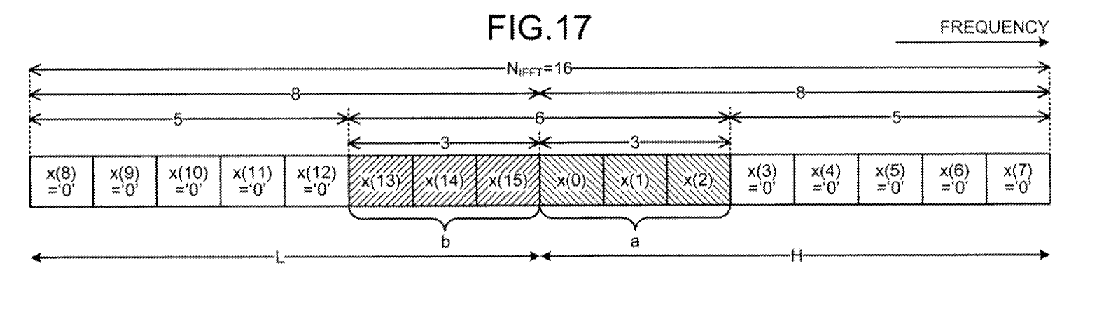

FIG. 17 is a view depicting a data arrangement example of the input data items x(0) to x(15) in the example depicted in FIG. 16. As depicted in FIGS. 17, x(0) to x(2) correspond to data a in FIGS. 12, and x(13) to x(15) correspond to data b in FIG. 12.

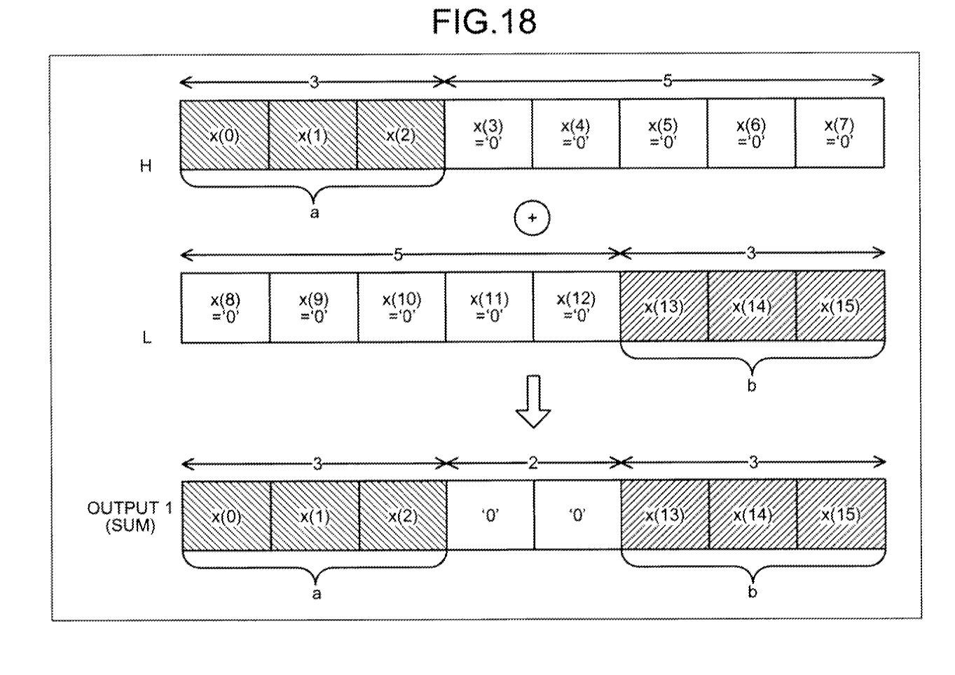

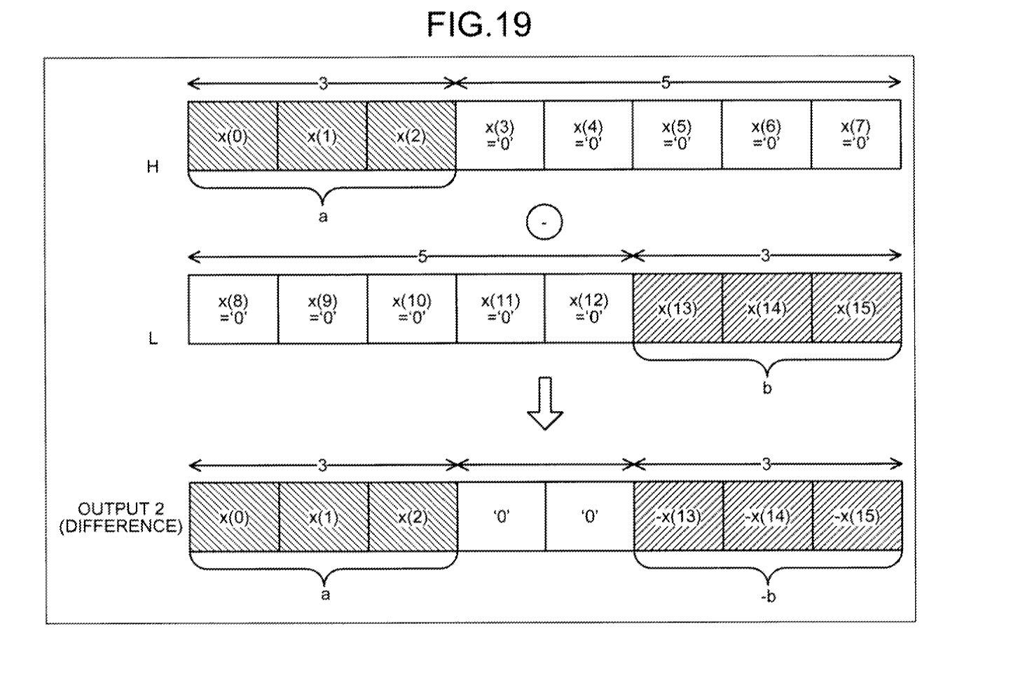

FIGS. 18 and 19 are views depicting the first stage butterfly computation processing in the examples depicted in FIGS. 16 and 17. Since all twiddle factors are 0, as depicted in FIG. 18, the H-side frequency allocated resources and the L-side frequency allocated resources are added. Further, as depicted in FIG. 19, the L-side frequency allocated resources are subtracted from the H-side frequency allocated resources.

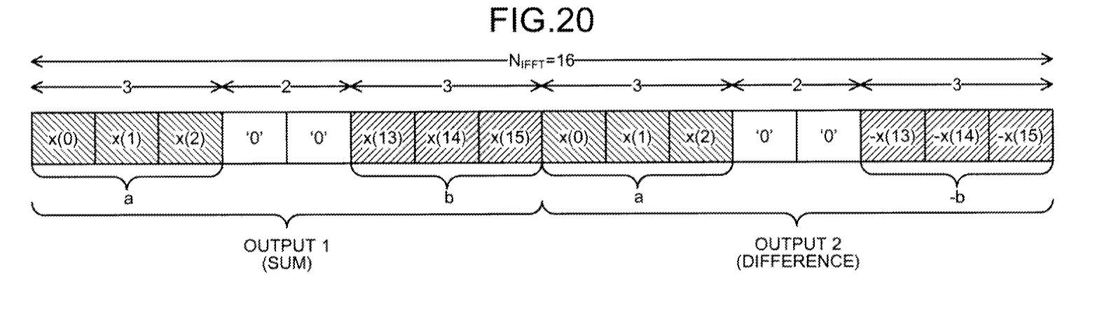

FIG. 20 is view depicting a data arrangement example after the first stage butterfly computation in the examples depicted in FIGS. 16 and 17. As depicted in FIG. 20, for example, arrangement is in the order of x(0) to x(2), zero, zero, x(13) to x(15), x(0) to x(2), zero, zero, and [−x(13)] to [−x(15)], from the low frequency side.

A data arrangement example after subcarrier mapping processing when expression (3) is satisfied will be described.

$$\frac{{N}_{IFFT}}{2} < {N}_{RB}^{UL} {N}_{SC}^{RB} \qquad ( 3 )$$

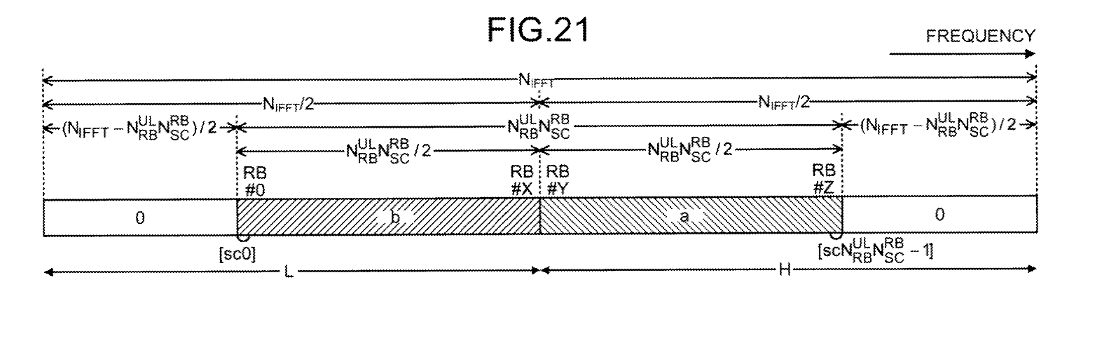

FIG. 21 is a view depicting a data arrangement example after subcarrier mapping processing under conditions satisfying expression (3). As depicted in FIG. 21, under conditions satisfying expression (3), mapping is in the order of zero, data b, data a, and zero, from the low frequency side. In FIG. 21, X, Y and Z are expressed by equations (2a), (2b) and (2c).

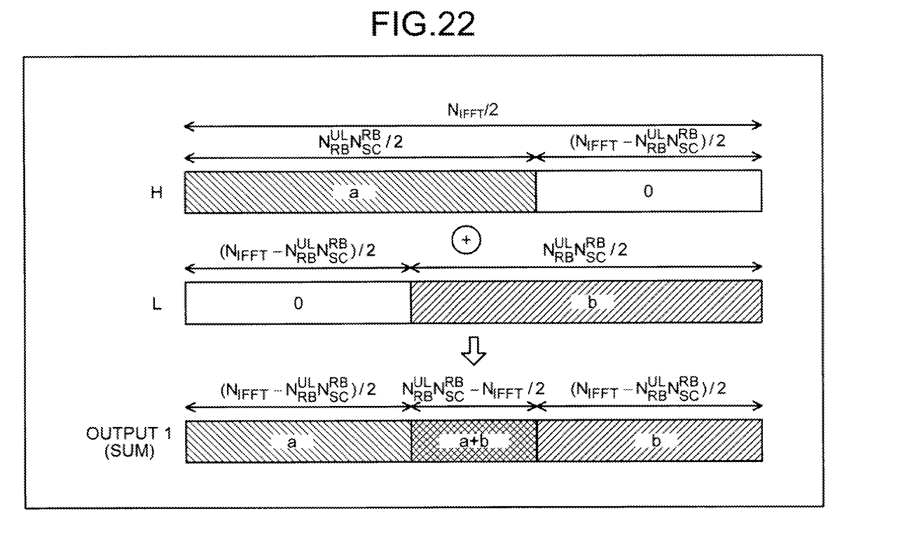

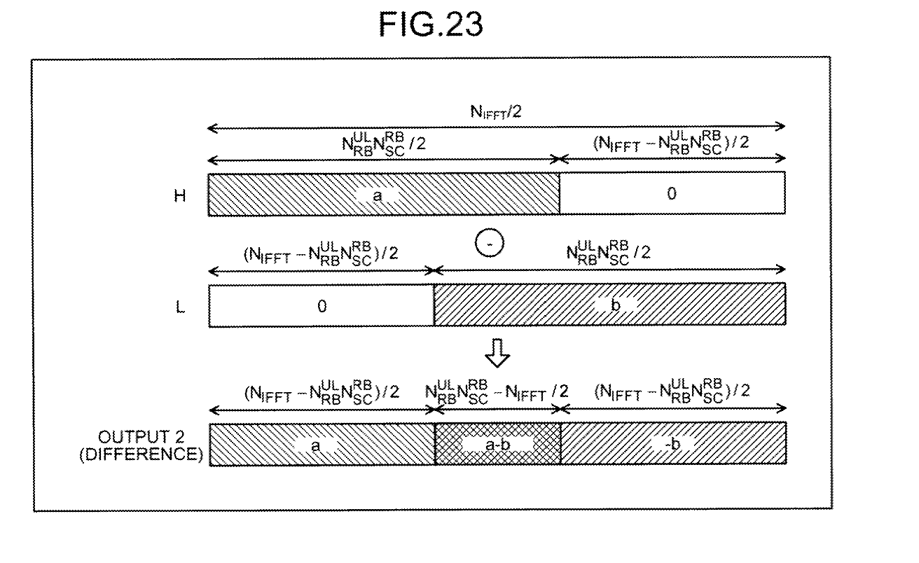

A data arrangement example after first stage butterfly computation processing when expression (3) is satisfied will be described. FIGS. 22 and 23 are views depicting first stage butterfly computation processing under conditions satisfying expression (3). As described above, in the first stage butterfly computation, H-side frequency allocated resources and L-side frequency allocated resources are added (see FIG. 22) and L-side frequency allocated resources are subtracted from H-side frequency allocated resources (see FIG. 23).

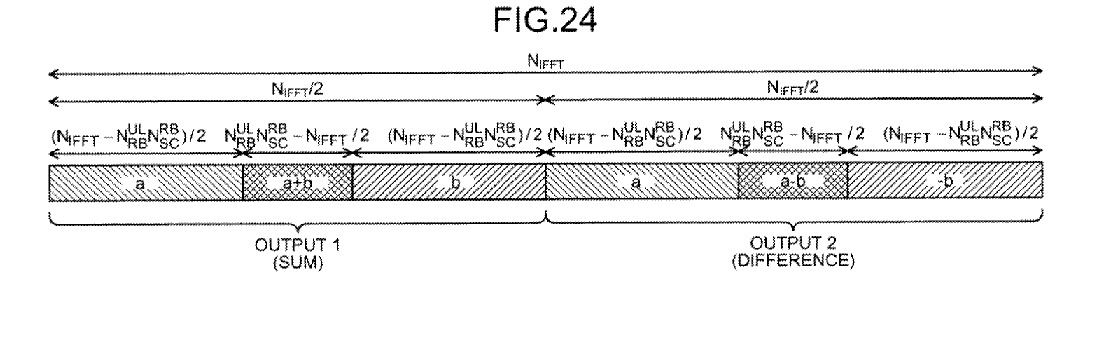

FIG. 24 is a view depicting a data arrangement example after first stage butterfly computation processing under conditions satisfying expression (3). As depicted in FIG. 24, after the first stage butterfly computation processing, the output 1 (sum) depicted in FIG. 22 is arranged on the low frequency side, and the output 2 (difference) depicted in FIG. 23 is arranged on the high frequency side. Thus, arrangement is in the order of data a, data [a+b], data b, data a, data [a−b], and data [−b], from the low frequency side.

A data arrangement example after subcarrier mapping processing when expressions (3) and (4) are satisfied will be described.

$${M}_{RB} \leq {N}_{RB}^{UL} - ceiling ( \frac{{N}_{RB}^{UL} {N}_{SC}^{RB} - \frac{{N}_{IFFT}}{2}}{{N}_{SC}^{RB}} ) \qquad ( 4 )$$

Here, M_{RB} is the resource block length of allocated data. ceiling[ ] indicates that the value after the decimal within [ ] is rounded up. For example, when N_{IFFT} is 2048 and N^{UL}_{RB} is 100 (system bandwidth: 20 MHz), M_{RB} satisfying expression (4) is 85 or less.

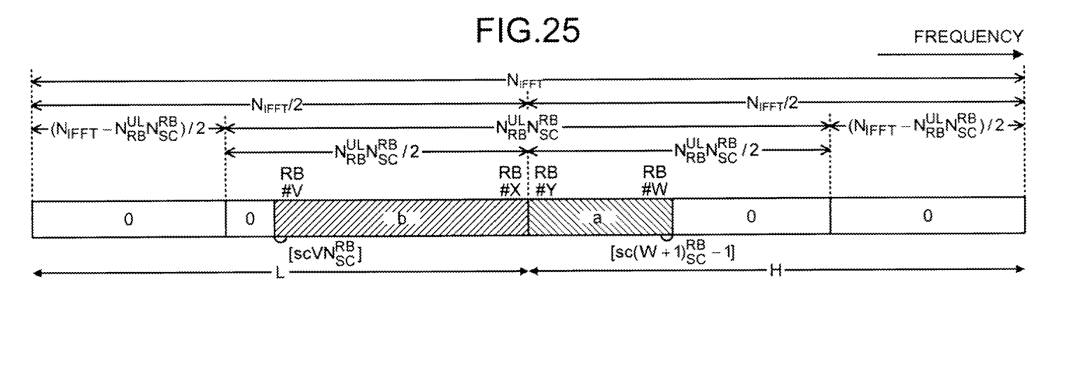

FIG. 25 is a view depicting a data arrangement example after subcarrier mapping processing under conditions satisfying expressions (3) and (4). As depicted in FIG. 25, under conditions satisfying expressions (3) and (4), mapping is in the order of zero, data b, data a, and zero, from the low frequency side.

In FIG. 25, the data resource block length is M_{RB}, data from resource block #V to resource block #W is allocated. X, Y and M_{RB} are expressed by equations (5a), (5b) and (5c).

$$\begin{matrix}X = ( \frac{{N}_{RB}^{UL}}{2} - 1 ) & ( 5 a ) \\ Y = ( \frac{{N}_{RB}^{UL}}{2} ) & ( 5 b ) \\ {M}_{RB} = W - V + 1 & ( 5 c )\end{matrix}$$

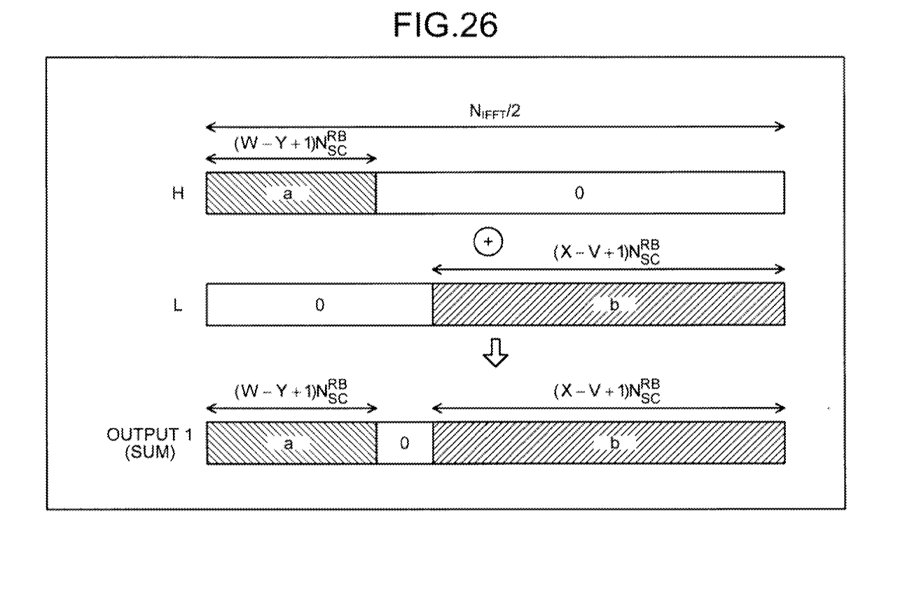

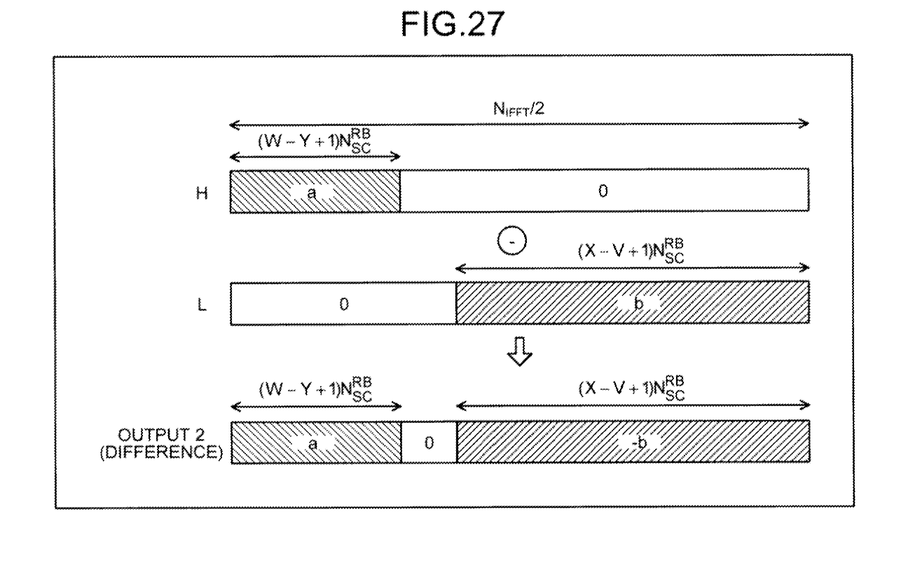

A data arrangement example after first stage butterfly computation processing when expressions (3) and (4) are satisfied will be described. FIGS. 26 and 27 are views depicting first stage butterfly computation processing under conditions satisfying expressions (3) and (4). As described above, in the first stage butterfly computation, the H-side frequency allocated resources and the L-side frequency allocated resources are added (see FIG. 26), and the L-side frequency allocated resources are subtracted from the H-side frequency allocated resources (see FIG. 27).

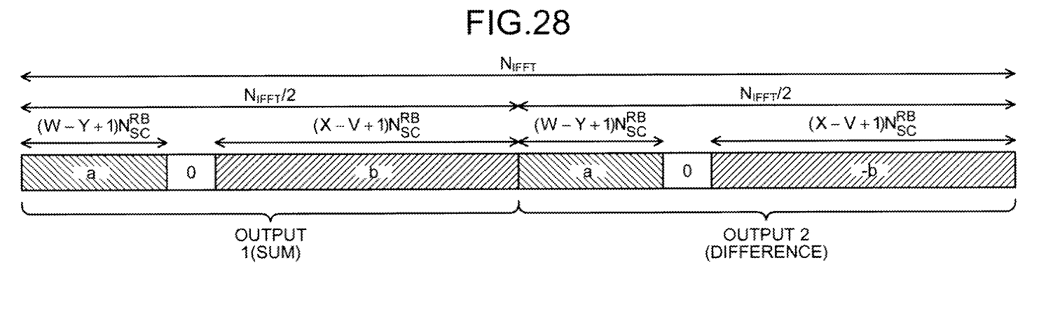

FIG. 28 is a view depicting a data arrangement example after first stage butterfly computation processing under conditions satisfying expressions (3) and (4). As depicted in FIG. 28, after the first stage butterfly computation processing, the output 1 (sum) depicted in FIG. 26 is arranged on the low frequency side, and the output 2 depicted in FIG. 27 (difference) is arranged on the high frequency side. Thus, arrangement is in the order of data a, zero, data b, data a, zero, and data [−b], from the low frequency side.

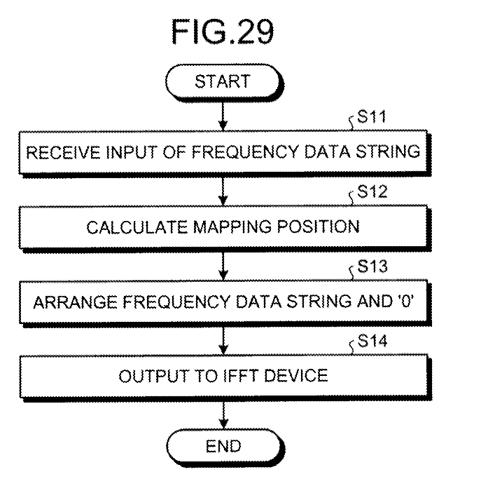

FIG. 29 is a flowchart of the radio communication method according to the second embodiment. As depicted in FIG. 29, in the radio communication method, when mapping processing begins, the subcarrier mapper 28 of the radio communication apparatus receives an input of a frequency data string mapped to a frequency domain that corresponds to frequency allocated resources (step S11)

The selection signal generator 44 of the subcarrier mapper 28 calculates a mapping position for each data item of the frequency data string (step S12), and based on the mapping positions, controls the switching of the selector 43. The selector 43 arranges in a frequency domain that corresponds to frequency allocated resources, each data item of the frequency data string and zeros (step S13). The subcarrier mapper 28 outputs the mapped data to the IFFT device 29 (step S14), ending the processing.

According to the third embodiment, in the radio communication apparatus and the radio communication method according to the second embodiment, data is mapped to subcarriers of a frequency domain that corresponds to frequency allocated resources, such that the data arrangement after the IFFT first stage butterfly computation processing is achieved. In the description and drawings hereinafter, components identical to those in the second embodiment are given the same reference numerals used in the second embodiment and redundant description is omitted.

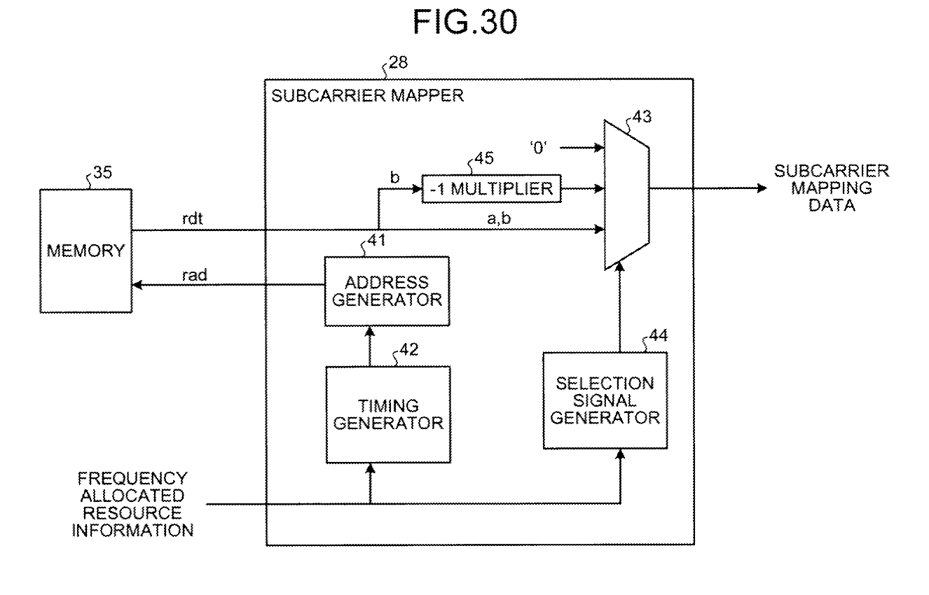

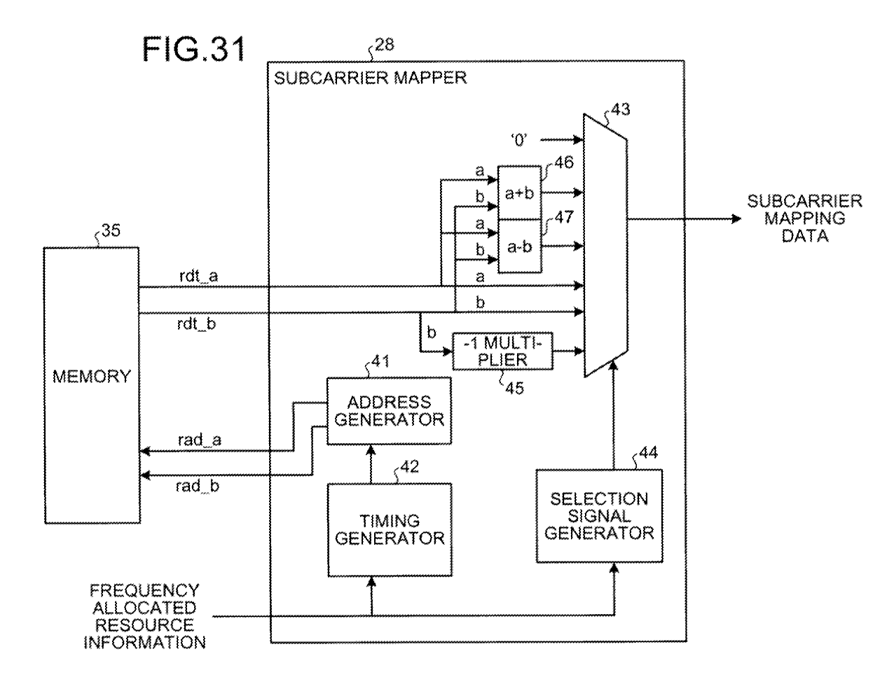

The radio communication apparatus according to the third embodiment, as an example of the mapper, includes the subcarrier mapper 28 depicted in FIG. 30 or FIG. 31, for example. FIG. 30 depicts the subcarrier mapper 28 when expression (1) is satisfied, or when expressions (3) and (4) are satisfied. FIG. 31 depicts the subcarrier mapper 28 when expression (3) is satisfied.

FIG. 30 is a block diagram of an example of the subcarrier mapper according to the third embodiment. In addition to the address generator 41, the timing generator 42, the selector 43 as an example of a selector, and the selection signal generator 44 described in the second embodiment, the subcarrier mapper 28 depicted in FIG. 30 further includes as an example of a first generator, a −1 multiplier 45.

The −1 multiplier 45, among the read data (rdt) readout from the memory 35, multiplies data b by [−1], generating [−b] data. The selector 43 selects data a, data b, data [−b], and zero, and maps the selected data to subcarriers of a frequency domain that corresponds to frequency allocated resources. In the subcarrier mapping data output from the subcarrier mapper 28, data a, zero, data b, data a, zero, and data [−b] are arranged, from the low frequency side.

The subcarrier mapping data when expression (1) is satisfied is as depicted in FIG. 15. The subcarrier mapping data when expressions (3) and (4) are satisfied is as depicted in FIG. 28.

FIG. 31 is a block diagram of another example of the subcarrier mapper according to the third embodiment. The subcarrier mapper 28 depicted in FIG. 31, in addition to the configuration depicted in FIG. 30, further includes as an example of a second generator, an a+b unit (adder) 46, and as an example of a third generator, an a−b unit (subtractor) 47.

The a+b unit 46 adds read data (rdt a) and read data (rdt b), which are readout from the memory 35, generating [a+b] data. The a−b unit 47 subtracts the read data (rdt b) from the read data (rdt a), generating [a−b] data.

The selector 43 selects data a, data b, data [a+b], data [a−b], and zero, and maps the selected data to subcarriers of a frequency domain that corresponds frequency allocated resources. In the subcarrier mapping data output from the subcarrier mapper 28 when expression (3) is satisfied, as depicted in FIG. 24, data a, data [a+b], data b, data a, data [a−b], and data [−b] are arranged sequentially, from the low frequency side. The subcarrier mapper 28 depicted in FIG. 31 can allocate zero and therefore is applicable when expression (1) is satisfied, or when expressions (3) and (4) are satisfied.

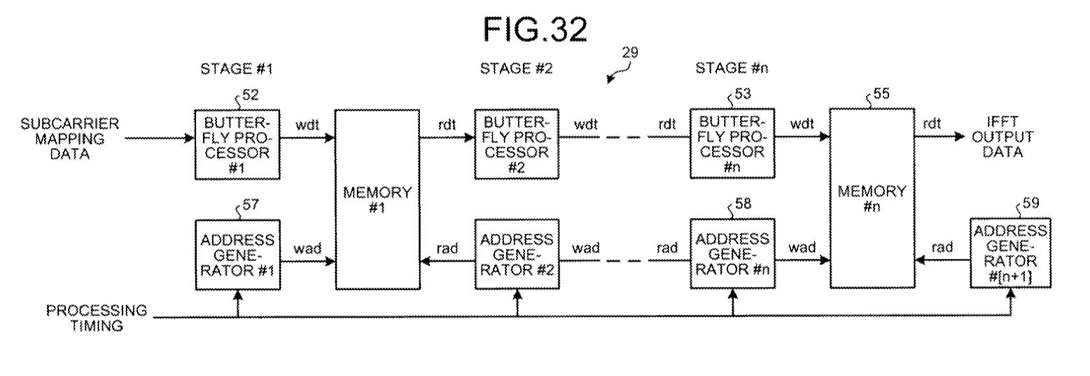

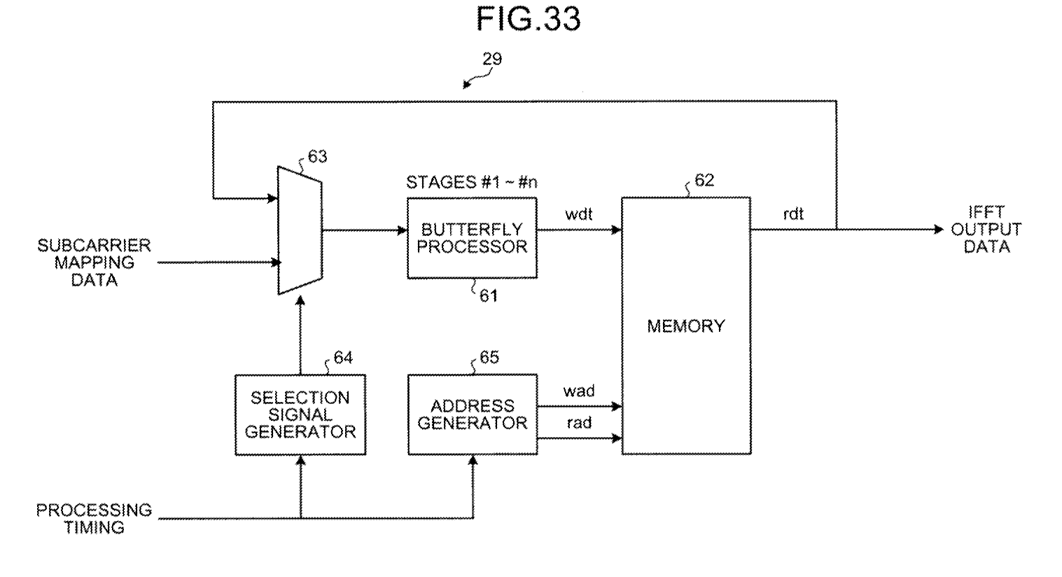

FIG. 32 is a block diagram of an example of the IFFT device according to the third embodiment. FIG. 33 is a block diagram of another example of the IFFT device according to the third embodiment. The radio communication apparatus according to the third embodiment, as an example of a calculator, includes the IFFT device 29 depicted in FIG. 32 or FIG. 33.

In the IFFT device 29 depicted in FIG. 32, stage #0 butterfly computation is omitted from the IFFT device 29 of the second embodiment (depicted in FIG. 10). In other words, the first stage butterfly processor#0, the memory#0 storing the first stage butterfly computation results, and the address generator#0 generating the write address (wad) for the memory#0 are omitted.

In the IFFT device 29 depicted in FIG. 33, stage #0 butterfly computation at the butterfly processor 61 is not performed as at the (second embodiment) IFFT device 29 depicted in FIG. 11. In other words, the butterfly processor 61 omits butterfly computation that corresponds to that at stage #0 as described in the second embodiment and performs butterfly computation that corresponds to that at stages #1 to #n as described in the second embodiment.

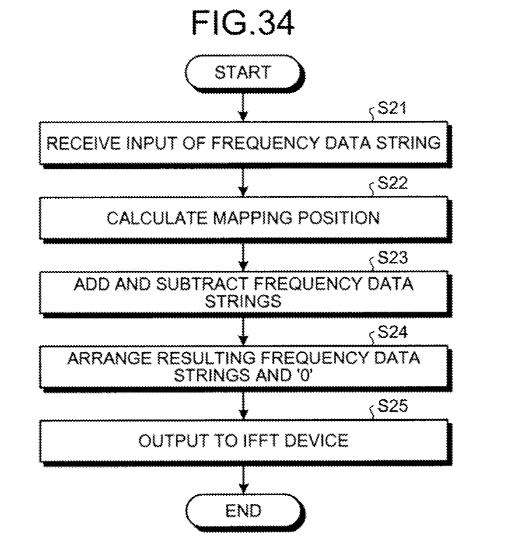

FIG. 34 is a flowchart of the radio communication method according to the third embodiment. As depicted in FIG. 34, in the radio communication method, when mapping processing begins, the subcarrier mapper 28 of the radio communication apparatus receives an input of a frequency data string mapped to a frequency domain that corresponds to frequency allocated resources (step S21).

The selection signal generator 44 of the subcarrier mapper 28 calculates mapping positions for each data item in the frequency data string (step S22), and based on the mapping positions, controls the switching of the selector 43. The −1 multiplier 45 multiplies data b by [−1]. The a+b unit 46 adds data b to data a and the a−b unit 47 subtracts data b from data a (step S23).

In a frequency domain that corresponds to frequency allocated resources, the selector 43 arranges each data item of the data strings generated by the multiplication, addition, and subtraction at step 23. If there is no allocable data, zero is arranged (step S24). The subcarrier mapper 28 outputs the mapped data to the IFFT device 29 (step S25), ending the processing.

According to the third embodiment, effects identical to those of the first embodiment can be obtained. For example, the volume of calculations at the IFFT device 29 can be reduced by 1 stage, the reduction rate of which is [(log₂N_{IFFT}−1)/log₂N_{IFFT}]. When N_{IFFT is} 2048, the volume of calculations at the IFFT device 29 can be reduced approximately 9%. Therefore, circuit size of the IFFT device 29, power consumption, and process delays can be decreased.

In the IFFT device 29 configured to have memory between each butterfly computation stage, for example, when N_{IFFT} is 2048, I (real) and Q (imaginary) of the butterfly computation results (complex values) stored in the memory are respectively 16-bit data, and independent memory for reading and writing are provided, 131072 bits (=[2048 [N_{IFFT}]>16[bits]×2[I, Q]×2[memory]]) can be reduced by not providing the memory#0 storing the first stage butterfly computation results. This reduction is substantial compared to the amount of increased processing consequent to the addition of the addition of the −1 multiplier 45, the a+b unit 46, and the a−b unit 47 in the subcarrier mapper 28.

In the IFFT device 29 configured to perform loop processing of the butterfly computation stages, for example, when N_{IFFT} is 2048 and the number of parallel butterfly computation devices in the butterfly processor 61 is 1, 1024 cycles (=[2048 [N_{IFFT}]/1[number of parallel butterfly computation devices]/2[butterfly computation device processing volume]]) can be reduced by not performing butterfly computation corresponding to stage #0. This reduction is substantial compared to the amount of increased processing consequent to the addition of the −1 multiplier 45, the a+b unit 46, and the a−b unit 47 in the subcarrier mapper 28.

Power consumption of the radio communication apparatus can be decreased. Processing delays in the radio communication apparatus can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio communication apparatus comprising
a mapper having:
a first generator that generates third data by inverting code of first data to be mapped to a frequency domain that corresponds to frequency allocated resources, and
a selector that selects the first data, second data to be mapped to the frequency domain that corresponds to frequency allocated resources, the third data generated by the first generator 2, and zero, wherein
the mapper maps to the frequency domain that corresponds to frequency allocated resources, the first data, the second data, the third data, and zero selected and output by the selector.

2. The radio communication apparatus according to claim 1, wherein
the mapper, from a low frequency side, sequentially maps the second data, zero, the first data, the second data, zero, and the third data.

3. The radio communication apparatus according to claim 1, wherein
the mapper further includes:
a second generator that generates fourth data by adding the first data to the second data, and
a third generator that generates fifth data by subtracting the first data from the second data,
the selector selects the first data, the second data, the third data, the fourth data generated by the second generator, and the fifth data generated by the third generator, and
the mapper maps to the frequency domain that corresponds to frequency allocated resources, the first data, the second data, the third data, the fourth data, and the fifth data selected by the selector.

4. The radio communication apparatus according to claim 3, wherein
the mapper, from a low frequency side, sequentially maps the second data, fourth data, the first data, the second data, fifth data, and the third data.

5. The radio communication apparatus according to claim 1, and further comprising
a calculator that performs butterfly computation for a plurality of stages, with respect to data mapped to the frequency domain by the mapper.

6. A radio communication method comprising:
generating third data by inverting code of first data to be mapped to a frequency domain that corresponds to frequency allocated resources; and
mapping to the frequency domain that corresponds to frequency allocated resources, the first data, second data to be mapped to the frequency domain, the third data, and zero.

7. The radio communication method according to claim 6, wherein
the mapping includes sequentially mapping, from a low frequency side, the second data, zero, the first data, the second data, zero, and the third data.

8. The radio communication method according to claim 6, and further comprising:
generating fourth data by adding the first data to the second data; and
generating fifth data by subtracting the first data from the second data, wherein
the mapping includes mapping to the frequency domain that corresponds to frequency allocated resources, the first data, the second data, the third data, the fourth data, and the fifth data.

9. The radio communication method according to claim 8, wherein
the mapping includes sequentially mapping, from a low frequency side, the second data, fourth data, the first data, the second data, fifth data, and the third data.

10. The radio communication method according to claim 6, and further comprising
performing butterfly computation for a plurality of stages with respect to data mapped to the frequency domain.
